(19) United States
(12) Patent Application Publication
(10) Pub. No.: US 2026/0046938 A1
(43) Pub. Date: Feb. 12, 2026

(54) RANDOM ACCESS OCCASION SELECTION FOR SUBBAND FULL DUPLEX-AWARE DEVICES

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Jae Ho RYU, San Diego, CA (US)

(21) Appl. No.: 19/258,879

(22) Filed: Jul. 2, 2025

Related U.S. Application Data
(60) Provisional application No. 63/681,722, filed on Aug. 9, 2024.

(51) Int. Cl. H04W 74/0833; H04B 7/06; H04L 5/14

(52) U.S. Cl. CPC H04W 74/0833; H04B 7/06952; H04L 5/14

(57) ABSTRACT

Methods, systems, and devices for wireless communications are described. A network entity may indicate, to a user equipment (UE), a probability value indicating a likelihood that the UE will select a subband full duplex (SBFD) random access occasion (RO) (e.g., instead of a non-SBFD RO) for an initial random access transmission. In case of random access failure, the UE may select another RO and retransmit a random access preamble. In some examples, the network may also configure one or more additional probability values for subsequent retransmissions. In some examples, the network entity may also provide one or more threshold values providing constraints for switching between types of ROs. The UE may transmit capability information to the network entity indicating its capability to switch between ROs of different types, quantities of times the UE is capable of switching or quantities of transmissions the UE supports before switching.

### CROSS REFERENCES

The present Application for Patent claims benefit of U.S. Provisional Patent Application No. 63/681,722 by ABOTABL et al., entitled “RANDOM ACCESS OCCASION SELECTION FOR SUBBAND FULL DUPLEX-AWARE DEVICES,” filed Aug. 9, 2024, assigned to the assignee hereof, and expressly incorporated herein.

### TECHNICAL FIELD

The following relates to wireless communications, including random access occasion selection for subband full duplex-aware devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving first control signaling indicating a first set of random access occasions (ROs) corresponding to a half duplex mode of operation, and a second set of ROs associated with a subband full duplex (SBFD) mode of operation, receiving second control signaling including an indication corresponding to selection of an RO from the second set of ROs, and transmitting a first random access message via a first RO of the first set of ROs or a second RO of the second set of ROs in accordance with the indication.

A UE for wireless communications is described. The UE may include one or more memories storing processor executable code, and one or more processors coupled with the one or more memories. The one or more processors may individually or collectively be operable to execute the code to cause the UE to receive first control signaling indicating a first set of ROs corresponding to a half duplex mode of operation, and a second set of ROs associated with a SBFD mode of operation, receive second control signaling including an indication corresponding to selection of a RO from the second set of ROs, and transmit a first random access message via a first RO of the first set of ROs or a second RO of the second set of ROs in accordance with the indication.

Another UE for wireless communications is described. The UE may include means for receiving first control signaling indicating a first set of ROs corresponding to a half duplex mode of operation, and a second set of ROs associated with a SBFD mode of operation, means for receiving second control signaling including an indication corresponding to selection of a RO from the second set of ROs, and means for transmitting a first random access message via a first RO of the first set of ROs or a second RO of the second set of ROs in accordance with the indication.

A non-transitory computer-readable medium storing code for wireless communications is described. The code may include instructions executable by one or more processors to receive first control signaling indicating a first set of ROs corresponding to a half duplex mode of operation, and a second set of ROs associated with a SBFD mode of operation, receive second control signaling including an indication corresponding to selection of a RO from the second set of ROs, and transmit a first random access message via a first RO of the first set of ROs or a second RO of the second set of ROs in accordance with the indication.

Some examples of the method, user equipment (UEs), and non-transitory computer-readable medium described herein may further include operations, features, means, or instructions for receiving, via the second control signaling, an indication of a set of multiple probability values including the probability value, each probability value of the set of multiple probability values corresponding to a respective beam of a set of beams.

Some examples of the method, user equipment (UEs), and non-transitory computer-readable medium described herein may further include operations, features, means, or instructions for establishing a radio resource control connection with a network device, where the second control signaling includes radio resource control signaling via the radio resource control connection.

Some examples of the method, user equipment (UEs), and non-transitory computer-readable medium described herein may further include operations, features, means, or instructions for operating in a radio resource control idle mode, where the second control signaling includes system information.

Some examples of the method, user equipment (UEs), and non-transitory computer-readable medium described herein may further include operations, features, means, or instructions for selecting the second RO of the second set of ROs based on a capability of the UE to support the SBFD mode of operation and including, in the first random access message transmitted via the second RO of the second set of ROs, an indication of the capability of the UE to support the SBFD mode of operation.

Some examples of the method, user equipment (UEs), and non-transitory computer-readable medium described herein may further include operations, features, means, or instructions for overriding a selection of the first RO according to the probability value based on a determination to transmit the indication of the capability via the first random access message, where selection of the second RO may be based on the overriding.

Some examples of the method, user equipment (UEs), and non-transitory computer-readable medium described herein may further include operations, features, means, or instructions for receiving, via the second control signaling, an indication of a second probability value for reselection of a RO and transmitting, based on failure of a first random access procedure and in accordance with the second probability value, a second random access message via a third RO of the first set of ROs or a fourth RO of the second set of ROs.

Some examples of the method, user equipment (UEs), and non-transitory computer-readable medium described herein may further include operations, features, means, or instructions for receiving, via the second control signaling, an indication of a threshold quantity of random access attempts, transmitting, based on a failure of a first random access procedure, a first set of one or more additional random access messages via the first set of ROs or the second set of ROs selected, in accordance with the indication, for transmission of the first random access message, and transmitting a second set of one or more additional random access messages based on a failure of one or more additional random access procedures corresponding to the first set of one or more additional random access messages and a total quantity of the first random access message and the first set of one or more additional random access messages satisfying the threshold quantity of random access attempts, where the first set of one or more additional random access messages may be transmitted via one of the first set of ROs or the second set of ROs, and the second set of one or more additional random access messages may be transmitted via the other of the first set of ROs or the second set of ROs.

Some examples of the method, user equipment (UEs), and non-transitory computer-readable medium described herein may further include operations, features, means, or instructions for receiving, via the second control signaling, an indication of a threshold quantity of times the UE may be to switch between transmission of random access messages via the first set of ROs and transmission of random access messages via the second set of ROs, transmitting one or more additional random access messages via the first set of ROs, the second set of ROs, or both, and refraining from switching between the first set of ROs and the second set of ROs based on a quantity of times the UE may have switched between the first set of ROs and the second set of ROs satisfying the threshold quantity.

Some examples of the method, user equipment (UEs), and non-transitory computer-readable medium described herein may further include operations, features, means, or instructions for receiving, via the second control signaling, an indication of a first threshold quantity of preamble transmissions corresponding to the half duplex mode of operation, and a second threshold quantity of preamble transmissions corresponding to the SBFD mode of operation, performing a first random access procedure corresponding to the first random access message via one of the first set of ROs or the second set of ROs, the first random access procedure including one or more retransmissions of the first random access message via the first set of ROs or the second set of ROs, and switching to the other of the first set of ROs or the second set of ROs for a second random access procedure based on a quantity of the one or more retransmissions satisfying the first threshold quantity of preamble transmissions.

Some examples of the method, user equipment (UEs), and non-transitory computer-readable medium described herein may further include operations, features, means, or instructions for performing the second random access procedure corresponding to a second random access message via the other of the first set of ROs or the second set of ROs in accordance with the switching, the second random access procedure including one or more retransmissions of the second random access message via the other of the first set of ROs or the second set of ROs and refraining from switching back to the first set of ROs until a quantity of the one or more retransmissions of the second random access message satisfying the second threshold quantity of preamble transmissions.

Some examples of the method, user equipment (UEs), and non-transitory computer-readable medium described herein may further include operations, features, means, or instructions for receiving, based on transmitting the first random access message via the second RO of the second set of ROs, a random access response including an indication to default to the first set of ROs and transmitting a second random access message via a RO of the first set of ROs in accordance with the indication to default to the first set of ROs.

Some examples of the method, user equipment (UEs), and non-transitory computer-readable medium described herein may further include operations, features, means, or instructions for receiving, via the second control signaling, a threshold quantity of preamble transmissions via the second set of ROs, transmitting a set of multiple random access preambles including the first random access message via the second set of ROs, and transmitting one or more random access preambles via the first set of ROs based on a quantity of the set of multiple random access preambles satisfying the threshold quantity of preamble transmissions.

Some examples of the method, user equipment (UEs), and non-transitory computer-readable medium described herein may further include operations, features, means, or instructions for transmitting capability information indicating whether the UE supports switching between the first set of ROs and the second set of ROs, a threshold quantity of random access attempts the UE supports prior to switching between the first set of ROs and the second set of ROs, a threshold quantity of times the UE supports prior to switching between the first set of ROs and the second set of ROs, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports random access occasion (RO) selection for subband full duplex (SBFD)-aware devices in accordance with one or more aspects of the present disclosure.

FIG. 2 shows an example of a wireless communications system that supports RO selection for SBFD-aware devices in accordance with one or more aspects of the present disclosure.

FIG. 3 shows an example of a process flow that supports RO selection for SBFD-aware devices in accordance with one or more aspects of the present disclosure.

FIGS. 4 and 5 show block diagrams of devices that support RO selection for SBFD-aware devices in accordance with one or more aspects of the present disclosure.

FIG. 6 shows a block diagram of a communications manager that supports RO selection for SBFD-aware devices in accordance with one or more aspects of the present disclosure.

FIG. 7 shows a diagram of a system including a device that supports RO selection for SBFD-aware devices in accordance with one or more aspects of the present disclosure.

FIGS. 8 through 10 show flowcharts illustrating methods that support RO selection for SBFD-aware devices in accordance with one or more aspects of the present disclosure.

### DETAILED DESCRIPTION

A user equipment (UE) may perform a random access procedure. In some examples, the UE may receive downlink signaling (e.g., synchronization signal physical broadcast channel (PBCH) blocks (SSBs)) via one or more beams, and may select a random access occasion (RO) based thereon for transmission of a first random access message (e.g., a random access preamble). In some examples, the network entity may configure the UE with a first set of ROs and a second set of ROs. The second set of ROs may be subband full duplex (SBFD) ROs located in an uplink subband of an SBFD time interval (e.g., slot). The first set of ROs may be non-SBFD ROs located in uplink or flexible slots. For an SBFD aware UE, the SBFD ROs may be invalid (e.g., or the UE may not be configured with or have access to the second set of ROs). For an SBFD aware UE, the UE may be capable of selecting either a non-SBFD RO or an SBFD RO via which to transmit a random access preamble. Such a selection may be performed based on timing constraints, or transmit power constraints. However, if multiple UEs make their own determinations regarding selection of ROs, then multiple or many UEs may simultaneously make the same selection, which may result in random access collisions, failed random access procedures or delayed random access procedures, inefficient use of available system resources (e.g., if most or all UEs in a geographical area select the same type of ROs when other types of ROs are available), increased system latency, and decreased user experience.

Techniques described herein support RO selection, and in some cases switching between types of ROs, according to some network control or influence. For example, the network entity may indicate, to the UE, a probability value indicating a likelihood that the UE will select an SBFD RO (e.g., instead of a non-SBFD RO) for an initial random access transmission. In case of random access failure, the UE 115 may select another RO and retransmit a random access preamble. In some examples, the network may also configure one or more additional probability values for subsequent retransmissions. In some examples, the network entity may also provide one or more threshold values providing constraints for switching between types of ROs. For instance, the network entity may configure the UE with a threshold quantity of random access attempts or transmission the UE is to perform prior to switching from one type of RO to another, a threshold quantity of times the UE is permitted to switch between one type of RO and the other type of RO, instructions to refrain from switching between ROs during a random access attempt, among other examples. The UE may transmit capability information to the network entity indicating its capability to switch between ROs of different types, or quantities of times the UE is capable of switching or quantities of transmissions the UE supports before switching. Such techniques may result in improved throughput, more efficient random access procedures, more efficient use of available ROs and system resources, decreased system latency, and improved user experience.

Aspects of the disclosure are initially described in the context of wireless communications systems. Aspects of the disclosure are further illustrated by and described with reference to wireless communications systems and process flows. Aspects of the disclosure are further illustrated by and described with reference to apparatus diagrams, system diagrams, and flowcharts that relate to RO selection for SBFD-aware devices.

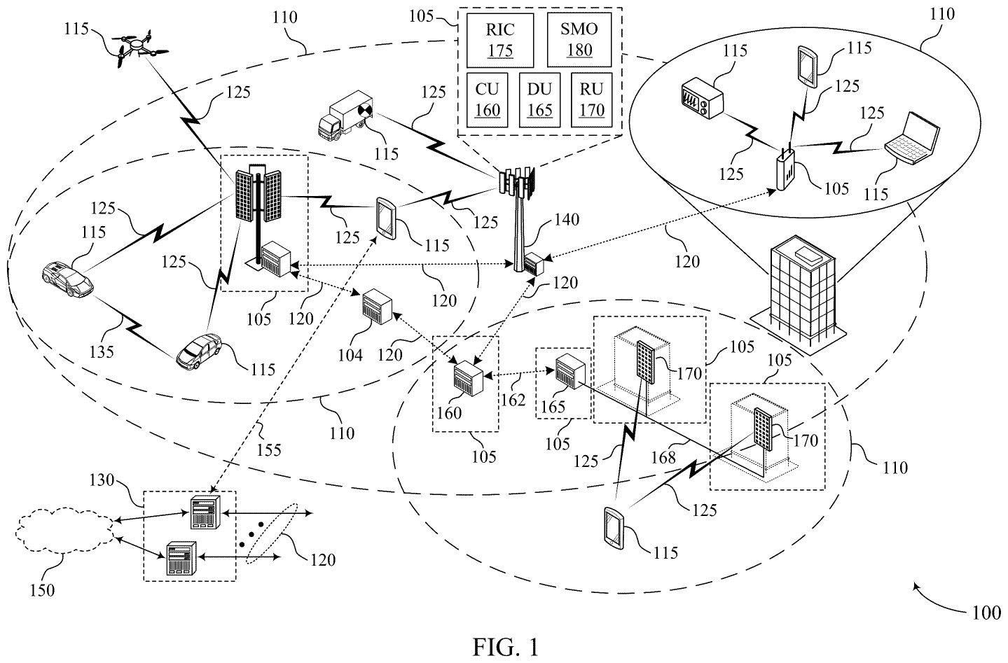

FIG. 1 shows an example of a wireless communications system 100 that supports RO selection for SBFD-aware devices in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, or a personal computer,, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions.

Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas.

Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Techniques described herein support RO selection, and in some cases switching between types of ROs, according to some network control or influence. For example, the network entity may indicate, to the UE 115, a probability value indicating a likelihood that the UE 115 will select an SBFD RO (e.g., instead of a non-SBFD RO) for an initial random access transmission. In case of random access failure, the UE 115 may select another RO and retransmit a random access preamble. In some examples, the network may also configure one or more additional probability values for subsequent retransmissions. In some examples, the network entity may also provide one or more threshold values providing constraints for switching between types of ROs. For instance, the network entity may configure the UE 115 with a threshold quantity of random access attempts or transmission the UE 115 is to perform prior to switching from one type of RO to another, a threshold quantity of times the UE 115 is permitted to switch between one type of RO and the other type of RO, instructions to refrain from switching between ROs during a random access attempt, among other examples. The UE may transmit capability information to the network entity indicating its capability to switch between ROs of different types, or quantities of times the UE 115 is capable of switching or quantities of transmissions the UE supports before switching.

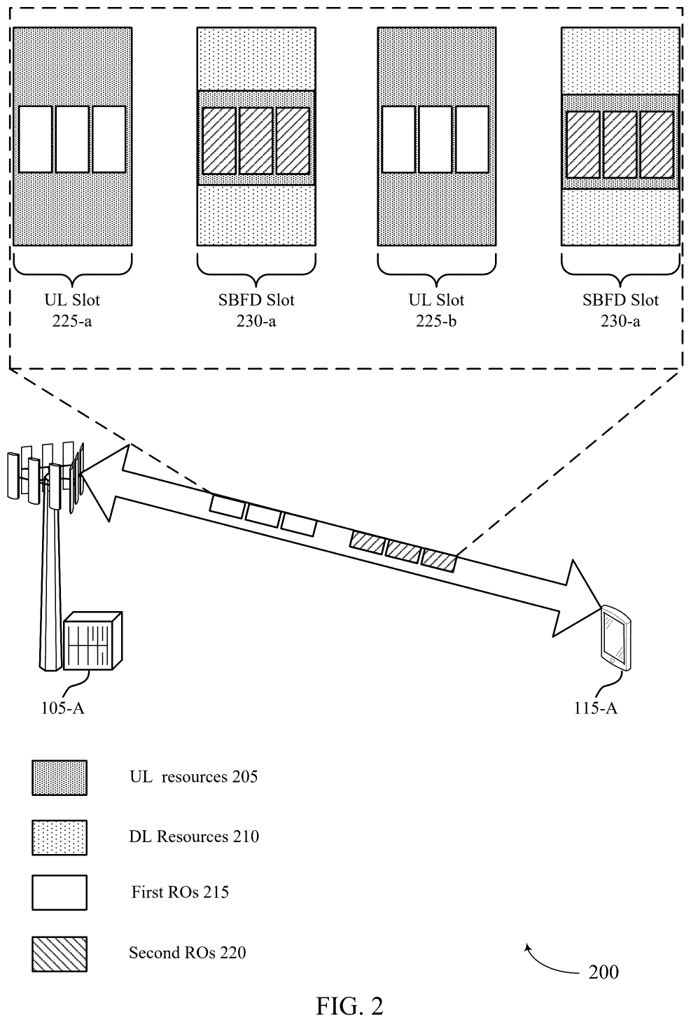

FIG. 2 shows an example of a wireless communications system 200 that supports RO selection for SBFD-aware devices in accordance with one or more aspects of the present disclosure. The wireless communications system 200 may implement, or be implemented by, aspects of the wireless communications system 100. For example, the wireless communications system 200 may include a network entity 105-a and a UE 115-a, which may be examples of corresponding devices described with reference to FIG. 1.

The wireless communications system may support random access communications. For example, the UE 115-a may monitor for one or more synchronization signal physical broadcast channel blocks (SSBs) and may select a corresponding RO via which to transmit a first random access message (e.g., RO). Some ROs (e.g., first ROs 215) may be located in uplink or flexible slots (e.g., UL slots 225). Some ROs (e.g., second ROs 220) may be located in UL resources 205 (e.g., an uplink subband) in an SBFD slots 230 (e.g., which includes both UL resources 205 and DL resources 210). In some examples, first ROs 215 may be referred to as legacy ROs, and second ROs 220 maybe referred to as SBFD ROs. Some wireless devices may not support SBFD modes of operation, and may only be capable of transmitting random access signaling via the first ROs 215. Other UEs (e.g., SBFD-aware UEs) may be capable of transmitting random access signaling via the first ROs 215, and via the second ROs 220.

In some examples (e.g., where the UE 115-a and the network entity 105-a are operating in a connected mode, such as an RRC connected UE), the wireless communications system may support one or more configurations of the ROs. In some examples, the UE 115-a may receive control signaling including a single shared physical random access channel (PRACH) configuration indicating both the first ROs 215, and additional second ROs 220. A UE that is not capable of supporting the SBFD operations may consider the second ROs 220 (e.g., SBFD ROs) invalid. The UE 115-a may be an SBFD-aware UE, and may consider the second ROs 220 as valid ROs. For example, a single RACH configuration using a single PRACH configuration index may indicate both the first ROs 215 and the second ROs 220. Or, in some examples, two different RACH configuration with separate PRACH configuration indices may be utilized to configure the first ROs 215, and the second ROs 220. In some examples, the UE 115-a may receive a first configuration of the first ROs 215, and a second configuration (e.g., an SBFD-dedicated PRACH configuration) of the second ROs 220. In either scenario, the UE 115-a may be capable of selecting an RO of the first ROs 215, or an RO of the second RO 220 for transmitting a random access message.

The UE may select a first RO 215 or a second RO 220 based on one or more conditions or scenarios. For example, at a point in time after the UL slot 225-a, the next available (e.g., soonest occurring) RO may be an SBFD RO in the SBFD slot 230-a (or a non-SBFD RO in the UL slot 225-b may occur prior to the SBFD ROs in the SBFD slot 230-b). However, in the case of power control, it may be more beneficial to transmit a threshold transmit power, or a target received power, among other examples (e.g., even if the UE 115-a would need to wait longer for an RO that would satisfy some constraints). Further, if multiple UEs 115 served the network entity 105, selection of ROs by individual UEs may not result in optimal traffic or overall RO utilization for the wireless communications system 100. For example, SBFD-aware UEs may indicate SBFD capabilities to the network entity by transmitting random access signaling via SBFD ROs. If a large quantity (e.g., or all) SBFD aware UEs 115 in a geographic area select the next available ROs (e.g., second ROs 220 in the SBFD slot 230-a) or automatically select SBFD ROs in the SBFD slot 230-a to indicate SBFD capabilities, then there is a high likelihood of RACH collisions occurring, resulting in failed random access procedures, increased delays in random access procedures, increased system latency, increased system congestion, and less efficient use of available ROs. Such issues may be exacerbated by initial RO selection and additional RO selection in the case of a failed initial random access transmission or a failed random access procedures (e.g., multiple failed random access transmissions).

It may instead be beneficial for the network entity to influence some aspects of UE behavior in RO selection to ensure more efficient use of available system resources, more balanced selection of first ROs 215 and second ROs 220 by various UEs over time, resulting in increased throughput, more efficient random access procedures, more efficient use of available system resources including ROs, decreased system latency, and improved user experience. Further, such techniques may apply to initial random access transmissions and RO selection for subsequent random access transmissions (e.g., in the case of failed initial random access transmission or a failed random access procedures).

According to techniques described herein, for an RRC idle UE, the network entity may only have cell-level control for the UEs behavior. Some control maybe implemented by steering all SBFD-aware UEs supporting SBFD ROs to SBFD ROs via system information signaling (e.g., SIB). More flexible signaling may be used to configure a probability that an SBFD-aware UE supporting SBFD ROs selects the SBFD RO. Techniques described herein support criterial for initial selection (e.g., in a first PRACH attempt) between using first ROs 215 and second ROs 220. Techniques described herein may further support criteria for switching between types of ROs (e.g., or falling back from SBFD ROs to default or legacy ROs) after RACH attempts or failures.

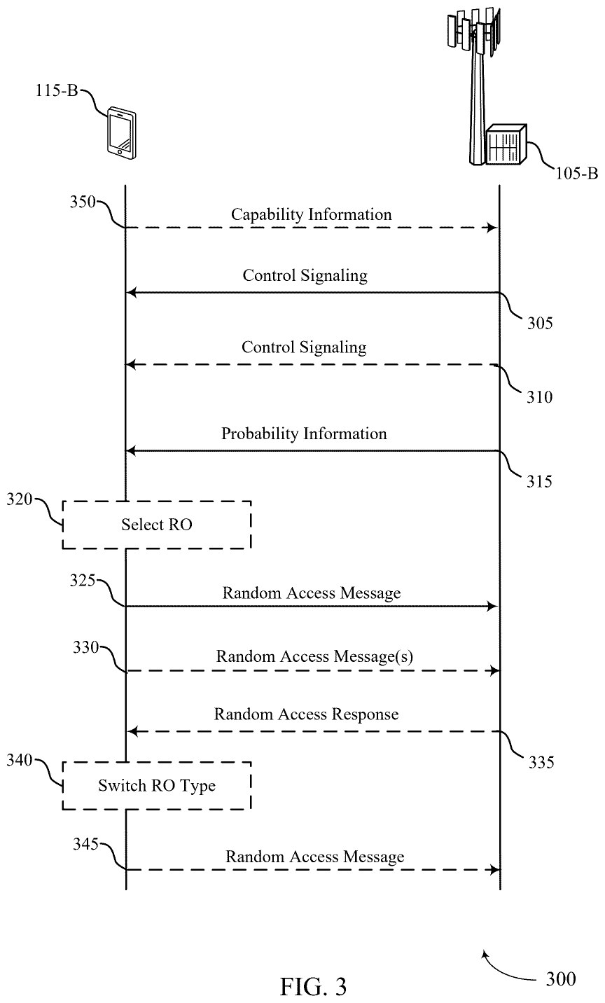

FIG. 3 shows an example of a process flow 300 that supports RO selection for SBFD-aware devices in accordance with one or more aspects of the present disclosure. The process flow 300 may implement, or be implemented by, aspects of the wireless communications system 100 and the wireless communications system 200. For example, the process flow 300 may include a UE 115-b and a network entity 105-b, which may be examples of corresponding devices described with reference to FIGS. 1-2.

At 305, the UE 115-b may receive control signaling indicating one or more RO configurations. For example, the first control signaling may indicate a first set of ROs. The first set of ROs may be located in uplink or flexible slots or symbols, and may correspond to a half duplex mode of operation. In some examples, the first control signaling may indicate a second set of ROs. The second set of ROs may be SBFD ROs, and may be associated with a SBFD mode of operation. In some examples, the UE 115-b may receive a single configuration of both the first and second sets of ROs (e.g., at 305). In some examples, the UE 115-b may receive a first configuration (e.g., a first control message at 305) indicating the first set of ROs, and a second configuration (e.g., a second control message at 310) indicating the second set of ROs.

At 315, the UE 115-b may receive probability information. For example, the UE 115-b may receive second control signaling including an indication (e.g., indicating a probability value) corresponding to selection of a RO from the second set of ROs. The probability information may correspond to a first PRACH attempt. For an RRC connected UE, the probability information may be received via semi-static signaling (e.g., gNB configuration received via RRC signaling). In some examples, for an RRC in idle or inactive mode, the probability information may be received via broadcast signaling (e.g., system information, such as a system information block (SIB)). The probability information may refer to a probability value (e.g., 0 percent, 20 percent, 50percent, 70 percent, 100 percent, or any other value). The probability value may indicate a likelihood that the UE 115-b will select the SBFD RO. For example, when the probability value is indicated to be 100 percent, the UE 115-b will always use an SBFD RO. When the probability is indicated to be 50 percent, then the UE 115-b may select either an SBFD RO from the second set of ROs or an RO from the first set of ROs (e.g., evenly, or with equal probability). When the probability is indicated to be 0 percent, the UE 115-b may disable random access procedures in SBFD ROs of the second set of ROs.

In some examples, whether the UE is permitted to use an SBFD RO may additional be subject to one or more constraints. For example, the UE 115-b may receive an indication of an RSRP threshold, or transmit power threshold (e.g., to control or mitigate inter-UE cross link interference (CLI)). In such examples, even if the probability value results in selection of an SBFD RO, the UE 115-b may instead select an RO of the first set of ROs if transmission via an SBFD RO would violate such constraints.

In some examples, the probability information may be configured for each beam (e.g., for each SSB, or each CSI-RS). For example, a first probability value may apply to a first beam, and a second (e.g., different) probably value may apply to a second beam. Selection of ROs for the first beam may be performed in accordance with the first probability value, and selection of ROs for the second beam may be performed in accordance with the second probability value.

In some examples, the UE 115-a may adapt the probability information to accommodate for latency requirements. For example, the UE may receive a first (e.g., configured) probability value. The UE may determine a new or updated probability value based on a value (e.g., α) times a timing offset (e.g., which may be referred to as time_delta_ROs), such that the new probably value is defined as new configured probability=conifgured probability+α·time [symbol] .

In some examples, for the first PRACH attempt, the UE 115-b (e.g., an SBFD aware UE) may select an SBFD RO from the second set of ROs if the UE 115-b is to indicate to the network entity 105-b capability information including SBFD awareness capabilities supported by the UE 115-b. For example, the UE 115-b may be an SBFD aware UE. Indicating SBFD awareness capabilities to the network entity 105-b may result in one or more advantages. For example, based on such reported capabilities, the network entity 105-b may schedule subsequent random access signaling (e.g., message 3 (Msg3) of a four-step random access procedure) in SBFD downlink slots to reduce random access latency, or the network entity 105-b may schedule message 3 repetitions across consecutive SBFD downlink symbols (e.g., uplink coverage), enabling physical uplink control channel (PUCCH) of message 4 of the four-step procedure in SBFD slots. The UE 115-b may therefore indicate the SBFD capability information to the network entity by selecting an SBFD RO for transmission of the first random access message. In some examples, to ensure indication of the SBFD awareness, the UE 115-b may select the SBFD RO even if the probability information indicates that the UE 115-b is to select a first SBFD RO of the first set of ROs (e.g., a legacy RO). In some examples, the UE 115-b may apply the probability value to an equation, model, or other deterministic procedure, and the UE 115-b may output an indication to either select an SBFD RO or not based at least in part on inputting the probability value.

At 320, the UE 115-b may select an RO. The UE 115-b may select either a first RO from the first set of ROs (e.g., a legacy RO) or a second RO from the second set of ROs (e.g., an SBFD RO).

At 325, the UE 115-b may transmit a first random access message (e.g., a random access preamble). The UE 115-b may transmit the random access message via the selected RO (e.g., either the first RO or the second RO).

Subsequent to transmission of the first random access message, in some examples, the UE 115-b may transmit one or more additional random access messages (e.g., at 335). For example, the UE 115-b may perform multiple PRACH attempts. In some examples, the UE 115-b may transmit multiple random access preambles (e.g., as part of a single PRACH attempt), and if no random access response message is received (e.g., within an amount of time or prior to expiration of a timer), the UE 115-b may determine that the PRACH attempt has failed.

The UE may select an RO for each PRACH transmission, each PRACH attempt, or a combination thereof. For example, at 330, the UE 115-b may perform one or more PRACH attempts. For these subsequent PRACH attempts, the network entity 105-b may configure (e.g., via the second control signaling, or other control signaling) at least a second (e.g., one or more additional) probability values to select or reselect an RO (e.g., an SBFD RO or a non-SBFD RO). For example, for each PRACH attempt, the UE 115-b may switch between SBFD ROs and non-SBFD ROs to meet an average of a certain load balance probability. In some examples, the network entity 105-b may indicate multiple probability values for multiple (e.g., a quantity) of PRACH attempts. For instance, the network entity 105-b may indicate a first probability value (e.g., 90 percent) for an initial or first random access transmissions (e.g., at 325), and a second probability value (e.g., 70 percent) for a second random access transmission (e.g., at 330). Additional probability values (e.g., 50 percent, 30 percent, or 10 percent) may be configured for each random access transmission or each PRACH attempt subsequent to the initial random access transmissions. In such examples, the UE 115-a (e.g., and other UEs 115) may be more likely over time to revert to non-SBFD ROs in the case that initial PRACH attempts or early PRACH attempts fail.

In some examples, the UE 115-b may switch between SBFD ROs and non-SBFD ROs over time. For example, the UE 115-b may perform random access attempts (e.g., at 325 and 330), which may fail. The UE 115-b may switch RO types at 340 (e.g., if the UE 115-b does not successfully receive a random access response at 335). For instance, if the UE 115-b has selected SBFD ROs at 320 or at 330 (e.g., based on the configured probability value), then at 340 the UE 115-b may switch to non-SBFD ROs, and may transmit a random access message (e.g., a random access preamble) at 345 via the other type of RO based on the switching. The network entity 105-b may configure the UE 115-b with a quantity (e.g., N) of PRACH attempts or PRACH transmissions that are to occur before the UE 115-b may switch to another type of RO (e.g., from SBFD ROs to non-SBFD ROs, or vice versa). The UE 115-b may receive an indication of such a threshold quantity N via the second control signaling, or via other control signaling. For example, if N=4 and the UE 115-b performs an initial PRACH attempt using SBFD ROs, then the UE 115-b may switch to non-SBFD ROs after four PRACH attempts (e.g., but may not switch to non-SBFD ROs until at least four PRACH attempts have been completed). Such a limitation may ensure that UEs 115 do not constantly or unnecessarily switch back and forth between types of ROs.

In some examples, the network entity 105-b may configure a total quantity of times that the UE 115-b is permitted to switch back and forth between types of ROs. For example, the UE may receive (e.g., via the second control signaling or other control signaling) an indication of a quantity of times (e.g., number of switching, or Ns) that the UE 115-b is permitted to switch between types of ROs within a PRACH procedure. For example, if Ns=0, and the UE 115-b may perform all PRACH procedures using the initially selected type of RO (e.g., the type of RO selected by the UE at 320 or before 330). If Ns=1, then the UE may switch once (e.g., at 340) from the type of RO selected by the UE at 320 or before 330.

For example, the UE 115-b may select SBFD ROs at 320, and may attempt a PRACH procedure (e.g., if N=10, then the UE 115-b may transmit up to ten random access preambles via SBFD ROs). If the PRACH attempt fails (e.g., if the UE 115-b does not receive a random access response for the up to ten preambles transmitted), then the UE 115-b may switch to non-SBFD ROs at 340. However, if Ns=1, even if one or more PRACH attempts fail after switching at 340, the UE 115-b may not switch back to SBFD ROs subsequent to the first switching at 340. In some examples, the UE 115-b may select an SBFD (e.g., based on a probability value of 50 percent). The UE may then select an SBFD RO based on the network configuration of a second probability value (e.g., fifty percent) for a preamble transmission (e.g., at 330). For N=1 and Ns=4, the UE 115-b may switch to non-SBFD ROs after the first random access preamble retransmission, and may be permitted to switch between SBFD ROs and non-SBFD ROs four times. After four switches, the UE 115-b may continue random access attempts using whatever the last type of RO was after the fourth switch.

In some examples, the UE 115-b may not be permitted to switch types of ROs within a random access procedure (e.g., within a set of PRACH attempts for random access preamble retransmission). For example, the network may configure the UE with a threshold quantity of preamble transmissions (e.g., preambleTransMax). If the UE 115-b transmits the indicated quantity of preamble transmissions (e.g., without receiving a random access response message), then the UE 115-b may determine (e.g., detect or declare) a failure, and may switch to another RO type. In some examples, the UE 115-b may be configured with multiple (e.g., two) threshold quantities of preamble transmissions (e.g., a first preambleTransMax and a second preambleTransMax), one for each type of available RO. In some examples, the UE 115-b may not switch between types of ROs during a random access attempt (e.g., the UE 115-b may perform random access attempts via the RO type selected at 320, but cannot switch to another type of RO until after the random access attempt is determined a failure by transmitting the first quantity of transmissions, satisfying the first preambleTransMax). The UE 115-b may then switch to another type of RO (e.g., according to N, Ns, or both), but may not perform another switch back to the first type of RO until after the second quantity of transmissions (e.g., the second preambleTransMax) is satisfied.

In some examples, the UE 115-b may be provided with additional dedicated PRACH configurations for SBFD random access procedures, and the UE 115-b may perform RO selection according to one or more restrictions. For example, if the UE 115-b receives a single PRACH configuration (e.g., at 305) indicating both the first and second sets of ROs, then the UE 115-b may be configured with a single preamble format across the first and second sets of ROs, with the same PRACH parameters for SBFD ROs and non-SBFD ROs. However, if the UE 115-b receives a first PRACH configuration (e.g., for the non-SBFD ROs at 305) and a second PRACH configuration (e.g., for SBFD ROs at 310), then switching to another type of RO may include switching preamble formats, or switching transmission power). Such switching may therefore correspond to additional overhead at the UE 115-b.

In some such examples (e.g., where the UE 115-b has been configured with two separate PRACH configurations), the UE 115-b may be permitted a single fallback or switch. For example, the UE may select SBFD ROs (e.g., at 320 or before 330) and may fall back to non-SBFD ROs if one or more conditions are satisfied, or if instructed to do so. In some examples, the UE 115-b may receive a random access response message (e.g., at 335). The response message may be a message 2 of a four-step random access procedure. The message 2 may indicate that the UE 115-b is to fall back to the first PRACH configuration (e.g., for non-SBFD ROs). In some examples, the UE 115-b may fall back or default to the non-SBFD ROs based on a threshold quantity of PRACH attempts or transmissions. IN some examples, the UE 115-b may select the random aces procedure using either type of RO (e.g., SBFD ROs or non-SBFD ROs), and the UE 115-b may then (e.g., autonomously, automatically, or according to one or more rules) switch to the other type of RO each time a random access procedure fails. In some examples, whether the UE switches to a default (e.g., as instructed in message 2, or upon a threshold quantity of ROs) or switches upon each failed random access failure may be configured (e.g., indicated via control signaling) by the network entity 105-b.

In some examples, the UE 115-b may report switching capability information to the network entity 105-b (e.g., at 350). The UE 115-b may indicate whether it supports switching between SBFD ROs and non-SBFD ROs, a direction of switching that is supported, a threshold (e.g., minimum) quantity of PRACH attempts supported before the UE 115-b can switch to the other type of RO, or a threshold (e.g., maximum) quantity of supported switches between the types of ROs within a PRACH procedure. In some examples, the UE 115-b may report one set of capabilities for the first type of ROs (e.g., non-SBFD ROs of the first set of ROs), and a second set of capabilities for the second type of ROs (e.g., SBFD ROs of the second set of ROs).

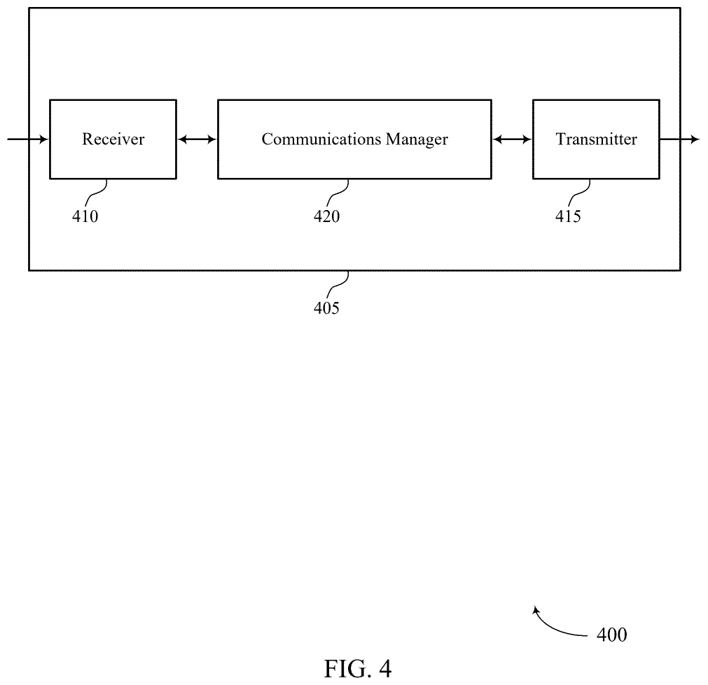

FIG. 4 shows a block diagram 400 of a device 405 that supports RO selection for SBFD-aware devices in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques.

Each of these components may be in communication with one another (e.g., via one or more buses).

The receiver 410 may provide a means for receiving information such as packets, user data, control information, or any combination thereof associated with various information channels (e.g., control channels, data channels, information channels related to RO selection for SBFD-aware devices). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to RO selection for SBFD-aware devices). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of RO selection for SBFD-aware devices as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving first control signaling indicating a first set of ROs corresponding to a half duplex mode of operation, and a second set of ROs associated with a SBFD mode of operation. The communications manager 420 is capable of, configured to, or operable to support a means for receiving second control signaling including an indication corresponding to selection of a RO from the second set of ROs. The communications manager 420 is capable of, configured to, or operable to support a means for transmitting a first random access message via a first RO of the first set of ROs or a second RO of the second set of ROs in accordance with the indication.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for RO selection and use resulting in more efficient power consumption, more efficient utilization of communication resources, decreased latency, and improved user experience.

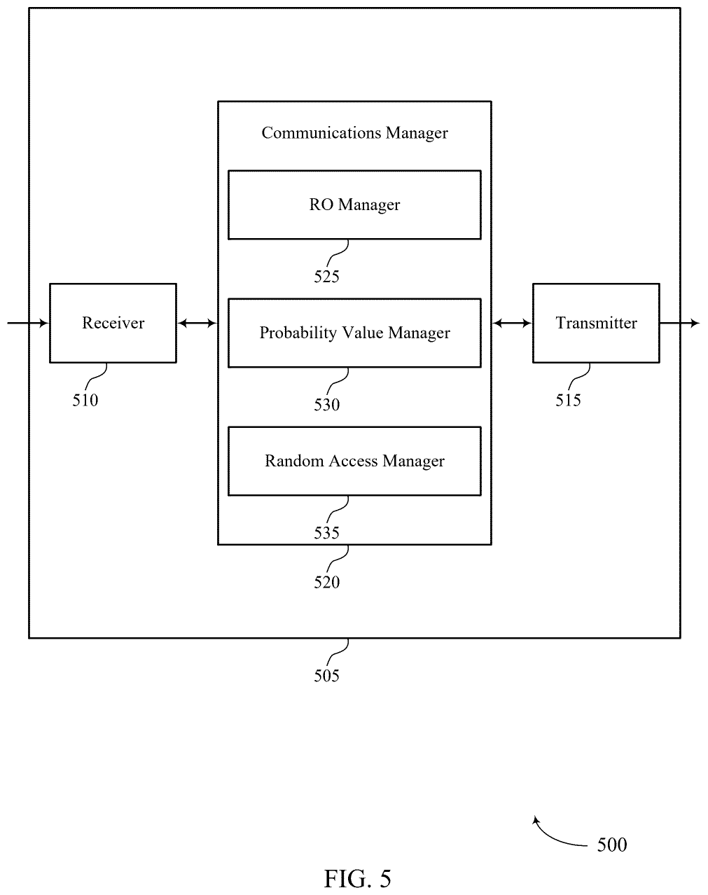

FIG. 5 shows a block diagram 500 of a device 505 that supports RO selection for SBFD-aware devices in accordance with one or more aspects of the present disclosure. The device 505 may be an example of aspects of a device 405 or a UE 115 as described herein. The device 505 may include a receiver 510, a transmitter 515, and a communications manager 520. The device 505, or one of more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to RO selection for SBFD-aware devices). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to RO selection for SBFD-aware devices). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of RO selection for SBFD-aware devices as described herein. For example, the communications manager 520 may include a RO manager 525, a probability value manager 530, a random access manager 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The RO manager 525 is capable of, configured to, or operable to support a means for receiving first control signaling indicating a first set of ROs corresponding to a half duplex mode of operation, and a second set of ROs associated with a SBFD mode of operation. The probability value manager 530 is capable of, configured to, or operable to support a means for receiving second control signaling including an indication corresponding to selection of a RO from the second set of ROs. The random access manager 535 is capable of, configured to, or operable to support a means for transmitting a first random access message via a first RO of the first set of ROs or a second RO of the second set of ROs in accordance with the indication.

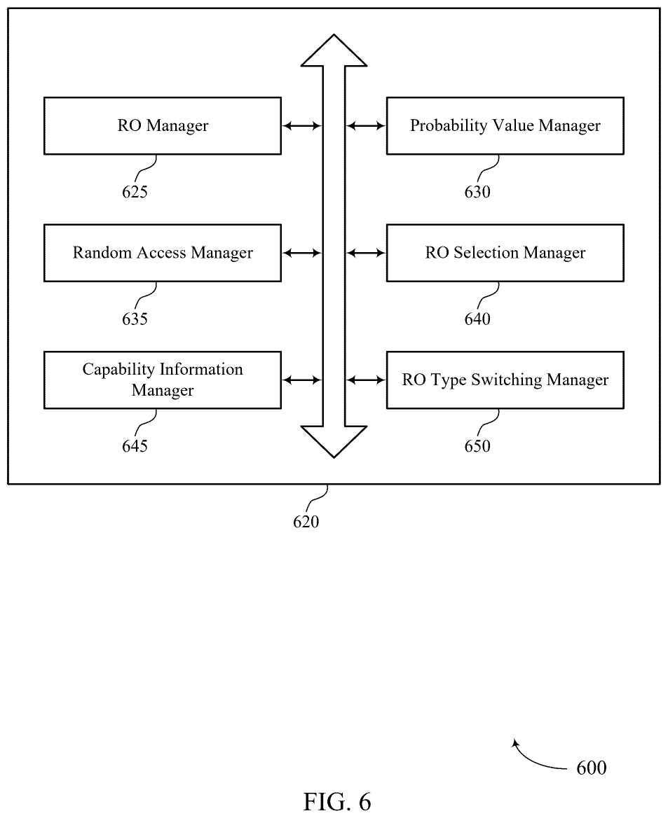

FIG. 6 shows a block diagram 600 of a communications manager 620 that supports RO selection for SBFD-aware devices in accordance with one or more aspects of the present disclosure. The communications manager 620 may be an example of aspects of a communications manager 420, a communications manager 520, or both, as described herein. The communications manager 620, or various components thereof, may be an example of means for performing various aspects of RO selection for SBFD-aware devices as described herein. For example, the communications manager 620 may include a RO manager 625, a probability value manager 630, a random access manager 635, a RO selection manager 640, a capability information manager 645, a RO type switching manager 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The RO manager 625 is capable of, configured to, or operable to support a means for receiving first control signaling indicating a first set of ROs corresponding to a half duplex mode of operation, and a second set of ROs associated with a SBFD mode of operation. The probability value manager 630 is capable of, configured to, or operable to support a means for receiving second control signaling including an indication corresponding to selection of a RO from the second set of ROs. The random access manager 635 is capable of, configured to, or operable to support a means for transmitting a first random access message via a first RO of the first set of ROs or a second RO of the second set of ROs in accordance with the indication.

In some examples, the probability value manager 630 is capable of, configured to, or operable to support a means for receiving, via the second control signaling, an indication of a set of multiple probability values including the probability value, each probability value of the set of multiple probability values corresponding to a respective beam of a set of beams.

In some examples, the probability value manager 630 is capable of, configured to, or operable to support a means for establishing a radio resource control connection with a network device, where the second control signaling includes radio resource control signaling via the radio resource control connection.

In some examples, the probability value manager 630 is capable of, configured to, or operable to support a means for operating in a radio resource control idle mode, where the second control signaling includes system information.

In some examples, the RO selection manager 640 is capable of, configured to, or operable to support a means for selecting the second RO of the second set of ROs based on a capability of the UE to support the SBFD mode of operation. In some examples, the capability information manager 645 is capable of, configured to, or operable to support a means for including, in the first random access message transmitted via the second RO of the second set of ROs, an indication of the capability of the UE to support the SBFD mode of operation.

In some examples, the RO selection manager 640 is capable of, configured to, or operable to support a means for overriding a selection of the first RO according to the probability value based on a determination to transmit the indication of the capability via the first random access message, where selection of the second RO is based on the overriding.

In some examples, the probability value manager 630 is capable of, configured to, or operable to support a means for receiving, via the second control signaling, an indication of a second probability value for reselection of a RO. In some examples, the RO selection manager 640 is capable of, configured to, or operable to support a means for transmitting, based on failure of a first random access procedure and in accordance with the second probability value, a second random access message via a third RO of the first set of ROs or a fourth RO of the second set of ROs.

In some examples, the random access manager 635 is capable of, configured to, or operable to support a means for receiving, via the second control signaling, an indication of a threshold quantity of random access attempts. In some examples, the RO selection manager 640 is capable of, configured to, or operable to support a means for transmitting, based on a failure of a first random access procedure, a first set of one or more additional random access messages via the first set of ROs or the second set of ROs selected, in accordance with the indication, for transmission of the first random access message. In some examples, the RO selection manager 640 is capable of, configured to, or operable to support a means for transmitting a second set of one or more additional random access messages based on a failure of one or more additional random access procedures corresponding to the first set of one or more additional random access messages and a total quantity of the first random access message and the first set of one or more additional random access messages satisfying the threshold quantity of random access attempts, where the first set of one or more additional random access messages is transmitted via one of the first set of ROs or the second set of ROs, and the second set of one or more additional random access messages is transmitted via the other of the first set of ROs or the second set of ROs.

In some examples, the RO type switching manager 650 is capable of, configured to, or operable to support a means for receiving, via the second control signaling, an indication of a threshold quantity of times the UE is to switch between transmission of random access messages via the first set of ROs and transmission of random access messages via the second set of ROs. In some examples, the RO type switching manager 650 is capable of, configured to, or operable to support a means for transmitting one or more additional random access messages via the first set of ROs, the second set of ROs, or both. In some examples, the RO type switching manager 650 is capable of, configured to, or operable to support a means for refraining from switching between the first set of ROs and the second set of ROs based on a quantity of times the UE has switched between the first set of ROs and the second set of ROs satisfying the threshold quantity.

In some examples, the RO type switching manager 650 is capable of, configured to, or operable to support a means for receiving, via the second control signaling, an indication of a first threshold quantity of preamble transmissions corresponding to the half duplex mode of operation, and a second threshold quantity of preamble transmissions corresponding to the SBFD mode of operation. In some examples, the RO type switching manager 650 is capable of, configured to, or operable to support a means for performing a first random access procedure corresponding to the first random access message via one of the first set of ROs or the second set of ROs, the first random access procedure including one or more retransmissions of the first random access message via the first set of ROs or the second set of ROs. In some examples, the RO type switching manager 650 is capable of, configured to, or operable to support a means for switching to the other of the first set of ROs or the second set of ROs for a second random access procedure based on a quantity of the one or more retransmissions satisfying the first threshold quantity of preamble transmissions.

In some examples, the RO type switching manager 650 is capable of, configured to, or operable to support a means for performing the second random access procedure corresponding to a second random access message via the other of the first set of ROs or the second set of ROs in accordance with the switching, the second random access procedure including one or more retransmissions of the second random access message via the other of the first set of ROs or the second set of ROs. In some examples, the RO type switching manager 650 is capable of, configured to, or operable to support a means for refraining from switching back to the first set of ROs until a quantity of the one or more retransmissions of the second random access message satisfying the second threshold quantity of preamble transmissions.

In some examples, the random access manager 635 is capable of, configured to, or operable to support a means for receiving, based on transmitting the first random access message via the second RO of the second set of ROs, a random access response including an indication to default to the first set of ROs. In some examples, the RO selection manager 640 is capable of, configured to, or operable to support a means for transmitting a second random access message via a RO of the first set of ROs in accordance with the indication to default to the first set of ROs.

In some examples, the RO type switching manager 650 is capable of, configured to, or operable to support a means for receiving, via the second control signaling, a threshold quantity of preamble transmissions via the second set of ROs. In some examples, the RO type switching manager 650 is capable of, configured to, or operable to support a means for transmitting a set of multiple random access preambles including the first random access message via the second set of ROs. In some examples, the RO type switching manager 650 is capable of, configured to, or operable to support a means for transmitting one or more random access preambles via the first set of ROs based on a quantity of the set of multiple random access preambles satisfying the threshold quantity of preamble transmissions.

In some examples, the capability information manager 645 is capable of, configured to, or operable to support a means for transmitting capability information indicating whether the UE supports switching between the first set of ROs and the second set of ROs, a threshold quantity of random access attempts the UE supports prior to switching between the first set of ROs and the second set of ROs, a threshold quantity of times the UE supports prior to switching between the first set of ROs and the second set of ROs, or any combination thereof.

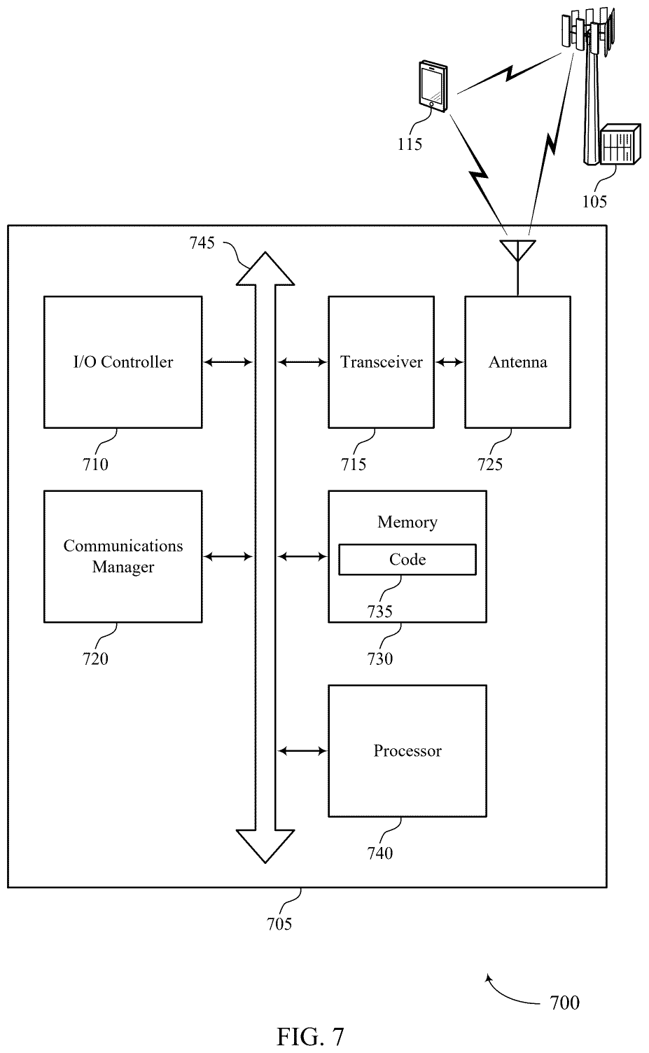

FIG. 7 shows a diagram of a system 700 including a device 705 that supports RO selection for SBFD-aware devices in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting RO selection for SBFD-aware devices). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving first control signaling indicating a first set of ROs corresponding to a half duplex mode of operation, and a second set of ROs associated with a SBFD mode of operation. The communications manager 720 is capable of, configured to, or operable to support a means for receiving second control signaling including an indication corresponding to selection of a RO from the second set of ROs. The communications manager 720 is capable of, configured to, or operable to support a means for transmitting a first random access message via a first RO of the first set of ROs or a second RO of the second set of ROs in accordance with the indication.

By including or configuring the communications manager 720 in accordance with examples as described herein, the device 705 may support techniques for RO selection and use resulting in more efficient power consumption, more efficient utilization of communication resources, improved coordination between devices, decreased device and system latency, more reliable wireless communications, decreased system congestion, and improved user experience.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of RO selection for SBFD-aware devices as described herein, or the at least one processor 740 and the at least one memory 730 may be otherwise configured to, individually or collectively, perform or support such operations.

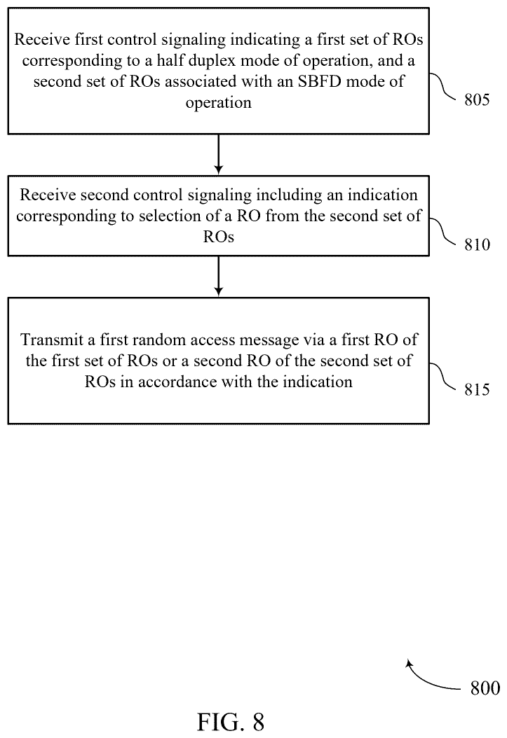

FIG. 8 shows a flowchart illustrating a method 800 that supports RO selection for SBFD-aware devices in accordance with one or more aspects of the present disclosure. The operations of the method 800 may be implemented by a UE or its components as described herein. For example, the operations of the method 800 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 805, the method may include receiving first control signaling indicating a first set of ROs corresponding to a half duplex mode of operation, and a second set of ROs associated with a SBFD mode of operation. The operations of 805 may be performed in accordance with examples as disclosed herein. In some examples, aspects of the operations of 805 may be performed by a RO manager 625 as described with reference to FIG. 6.

At 810, the method may include receiving second control signaling including an indication corresponding to selection of a RO from the second set of ROs. The operations of 810 may be performed in accordance with examples as disclosed herein. In some examples, aspects of the operations of 810 may be performed by a probability value manager 630 as described with reference to FIG. 6.

At 815, the method may include transmitting a first random access message via a first RO of the first set of ROs or a second RO of the second set of ROs in accordance with the indication. The operations of 815 may be performed in accordance with examples as disclosed herein. In some examples, aspects of the operations of 815 may be performed by a random access manager 635 as described with reference to FIG. 6.

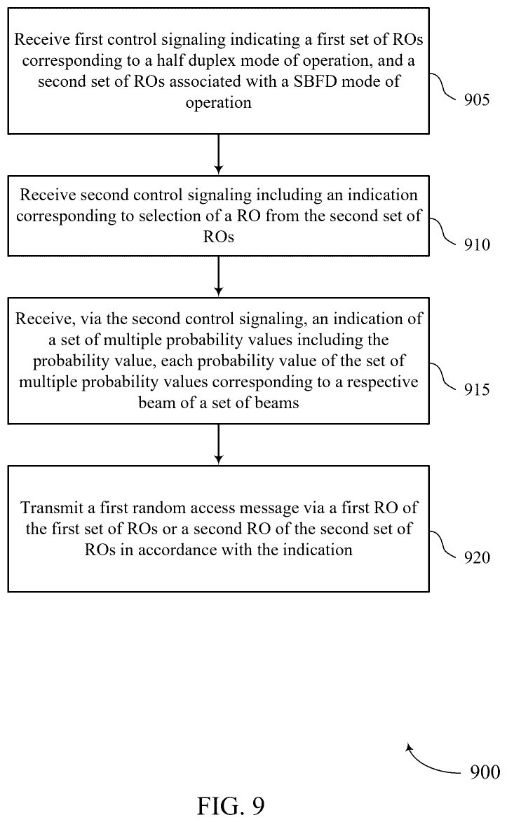

FIG. 9 shows a flowchart illustrating a method 900 that supports RO selection for SBFD-aware devices in accordance with one or more aspects of the present disclosure. The operations of the method 900 may be implemented by a UE or its components as described herein. For example, the operations of the method 900 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 905, the method may include receiving first control signaling indicating a first set of ROs corresponding to a half duplex mode of operation, and a second set of ROs associated with a SBFD mode of operation. The operations of 905 may be performed in accordance with examples as disclosed herein. In some examples, aspects of the operations of 905 may be performed by a RO manager 625 as described with reference to FIG. 6.

At 910, the method may include receiving second control signaling including an indication corresponding to selection of a RO from the second set of ROs. The operations of 910 may be performed in accordance with examples as disclosed herein. In some examples, aspects of the operations of 910 may be performed by a probability value manager 630 as described with reference to FIG. 6.

At 915, the method may include receiving, via the second control signaling, an indication of a set of multiple probability values including the probability value, each probability value of the set of multiple probability values corresponding to a respective beam of a set of beams. The operations of 915 may be performed in accordance with examples as disclosed herein. In some examples, aspects of the operations of 915 may be performed by a probability value manager 630 as described with reference to FIG. 6.

At 920, the method may include transmitting a first random access message via a first RO of the first set of ROs or a second RO of the second set of ROs in accordance with the indication. The operations of 920 may be performed in accordance with examples as disclosed herein. In some examples, aspects of the operations of 920 may be performed by a random access manager 635 as described with reference to FIG. 6.

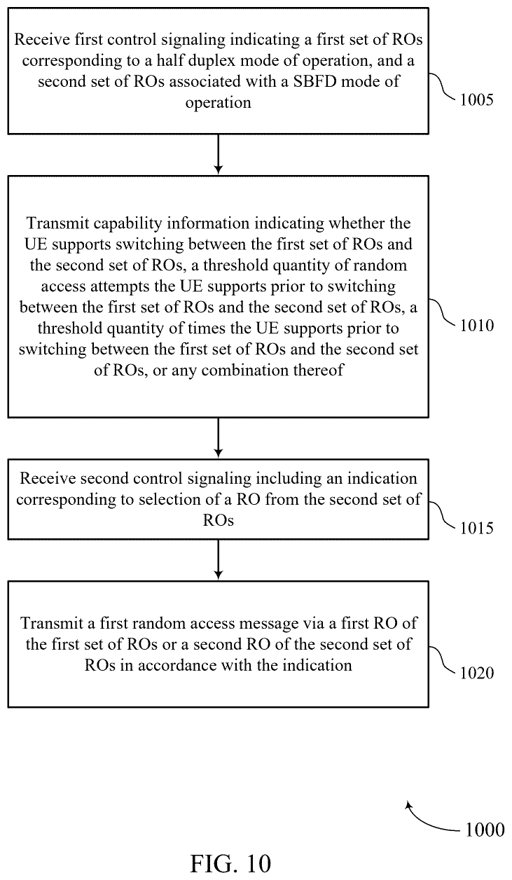

FIG. 10 shows a flowchart illustrating a method 1000 that supports RO selection for SBFD-aware devices in accordance with one or more aspects of the present disclosure. The operations of the method 1000 may be implemented by a UE or its components as described herein. For example, the operations of the method 1000 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1005, the method may include receiving first control signaling indicating a first set of ROs corresponding to a half duplex mode of operation, and a second set of ROs associated with a SBFD mode of operation. The operations of 1005 may be performed in accordance with examples as disclosed herein. In some examples, aspects of the operations of 1005 may be performed by a RO manager 625 as described with reference to FIG. 6.

At 1010, the method may include transmitting capability information indicating whether the UE supports switching between the first set of ROs and the second set of ROs, a threshold quantity of random access attempts the UE supports prior to switching between the first set of ROs and the second set of ROs, a threshold quantity of times the UE supports prior to switching between the first set of ROs and the second set of ROs, or any combination thereof. The operations of 1010 may be performed in accordance with examples as disclosed herein. In some examples, aspects of the operations of 1010 may be performed by a capability information manager 645 as described with reference to FIG. 6.

At 1015, the method may include receiving second control signaling including an indication corresponding to selection of a RO from the second set of ROs. The operations of 1015 may be performed in accordance with examples as disclosed herein. In some examples, aspects of the operations of 1015 may be performed by a probability value manager 630 as described with reference to FIG. 6.

At 1020, the method may include transmitting a first random access message via a first RO of the first set of ROs or a second RO of the second set of ROs in accordance with the indication. The operations of 1020 may be performed in accordance with examples as disclosed herein. In some examples, aspects of the operations of 1020 may be performed by a random access manager 635 as described with reference to FIG. 6.

The following provides an overview of aspects of the present disclosure:

Aspect 1: A method for wireless communications at a UE, comprising: receiving first control signaling indicating a first set of ROs corresponding to a half duplex mode of operation, and a second set of ROs associated with a SBFD mode of operation; receiving second control signaling including an indication corresponding to selection of a RO from the second set of ROs; and transmitting a first random access message via a first RO of the first set of ROs or a second RO of the second set of ROs in accordance with the indication.

Aspect 2: The method of aspect 1, further comprising: receiving, via the second control signaling, an indication of a plurality of probability values comprising the probability value, each probability value of the plurality of probability values corresponding to a respective beam of a set of beams.

Aspect 3: The method of any of aspects 1 through 2, further comprising: establishing a radio resource control connection with a network device, wherein the second control signaling comprises radio resource control signaling via the radio resource control connection.

Aspect 4: The method of any of aspects 1 through 3, further comprising: operating in a radio resource control idle mode, wherein the second control signaling comprises system information.

Aspect 5: The method of any of aspects 1 through 4, further comprising: selecting the second RO of the second set of ROs based at least in part on a capability of the UE to support the SBFD mode of operation; and including, in the first random access message transmitted via the second RO of the second set of ROs, an indication of the capability of the UE to support the SBFD mode of operation.

Aspect 6: The method of aspect 5, further comprising: overriding a selection of the first RO according to the probability value based at least in part on a determination to transmit the indication of the capability via the first random access message, wherein selection of the second RO is based at least in part on the overriding.

Aspect 7: The method of any of aspects 1 through 6, further comprising: receiving, via the second control signaling, an indication of a second probability value for reselection of a RO; and transmitting, based at least in part on failure of a first random access procedure and in accordance with the second probability value, a second random access message via a third RO of the first set of ROs or a fourth RO of the second set of ROs.

Aspect 8: The method of any of aspects 1 through 7, further comprising: receiving, via the second control signaling, an indication of a threshold quantity of random access attempts; transmitting, based at least in part on a failure of a first random access procedure, a first set of one or more additional random access messages via the first set of ROs or the second set of ROs selected, in accordance with the indication, for transmission of the first random access message; and transmitting a second set of one or more additional random access messages based at least in part on a failure of one or more additional random access procedures corresponding to the first set of one or more additional random access messages and a total quantity of the first random access message and the first set of one or more additional random access messages satisfying the threshold quantity of random access attempts, wherein the first set of one or more additional random access messages is transmitted via one of the first set of ROs or the second set of ROs, and the second set of one or more additional random access messages is transmitted via the other of the first set of ROs or the second set of ROs.

Aspect 9: The method of any of aspects 1 through 8, further comprising: receiving, via the second control signaling, an indication of a threshold quantity of times the UE is to switch between transmission of random access messages via the first set of ROs and transmission of random access messages via the second set of ROs; transmitting one or more additional random access messages via the first set of ROs, the second set of ROs, or both; and refraining from switching between the first set of ROs and the second set of ROs based at least in part on a quantity of times the UE has switched between the first set of ROs and the second set of ROs satisfying the threshold quantity.

Aspect 10: The method of any of aspects 1 through 9, further comprising: receiving, via the second control signaling, an indication of a first threshold quantity of preamble transmissions corresponding to the half duplex mode of operation, and a second threshold quantity of preamble transmissions corresponding to the SBFD mode of operation; performing a first random access procedure corresponding to the first random access message via one of the first set of ROs or the second set of ROs, the first random access procedure comprising one or more retransmissions of the first random access message via the first set of ROs or the second set of ROs; and switching to the other of the first set of ROs or the second set of ROs for a second random access procedure based at least in part on a quantity of the one or more retransmissions satisfying the first threshold quantity of preamble transmissions.

Aspect 11: The method of aspect 10, further comprising: performing the second random access procedure corresponding to a second random access message via the other of the first set of ROs or the second set of ROs in accordance with the switching, the second random access procedure comprising one or more retransmissions of the second random access message via the other of the first set of ROs or the second set of ROs; and refraining from switching back to the first set of ROs until a quantity of the one or more retransmissions of the second random access message satisfying the second threshold quantity of preamble transmissions.

Aspect 12: The method of any of aspects 1 through 11, further comprising: receiving, based at least in part on transmitting the first random access message via the second RO of the second set of ROs, a random access response comprising an indication to default to the first set of ROs; and transmitting a second random access message via a RO of the first set of ROs in accordance with the indication to default to the first set of ROs.

Aspect 13: The method of any of aspects 1 through 12, further comprising: receiving, via the second control signaling, a threshold quantity of preamble transmissions via the second set of ROs; transmitting a plurality of random access preambles comprising the first random access message via the second set of ROs; and transmitting one or more random access preambles via the first set of ROs based at least in part on a quantity of the plurality of random access preambles satisfying the threshold quantity of preamble transmissions.

Aspect 14: The method of any of aspects 1 through 13, further comprising: transmitting capability information indicating whether the UE supports switching between the first set of ROs and the second set of ROs, a threshold quantity of random access attempts the UE supports prior to switching between the first set of ROs and the second set of ROs, a threshold quantity of times the UE supports prior to switching between the first set of ROs and the second set of ROs, or any combination thereof.

Aspect 15: A UE for wireless communications, comprising one or more memories storing processor-executable code, and one or more processors coupled with the one or more memories and individually or collectively operable to execute the code to cause the UE to perform a method of any of aspects 1 through 14.

Aspect 16: A UE for wireless communications, comprising at least one means for performing a method of any of aspects 1 through 14.

Aspect 17: A non-transitory computer-readable medium storing code for wireless communications, the code comprising instructions executable by one or more processors to perform a method of any of aspects 1 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi) (e.g., IEEE 802.16 (WiMAX), IEEE 802.20), Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples. ” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first control signaling indicating a first set of random access occasions corresponding to a half duplex mode of operation, and a second set of random access occasions associated with a subband full duplex mode of operation;
receive second control signaling comprising an indication corresponding to selection of a random access occasion from the second set of random access occasions; and
transmit a first random access message via a first random access occasion of the first set of random access occasions or a second random access occasion of the second set of random access occasions in accordance with the indication.

2. The UE of claim 1, wherein the one or more processors are individually or collectively further operable to execute the code to cause the UE to:
receive, via the second control signaling, an indication of a plurality of probability values comprising a probability value, each probability value of the plurality of probability values corresponding to a respective beam of a set of beams.

3. The UE of claim 1, wherein the one or more processors are individually or collectively further operable to execute the code to cause the UE to:
establish a radio resource control connection with a network device, wherein the second control signaling comprises radio resource control signaling via the radio resource control connection.

4. The UE of claim 1, wherein the one or more processors are individually or collectively further operable to execute the code to cause the UE to:
operate in a radio resource control idle mode, wherein the second control signaling comprises system information.

5. The UE of claim 1, wherein the one or more processors are individually or collectively further operable to execute the code to cause the UE to:
select the second random access occasion of the second set of random access occasions based at least in part on a capability of the UE to support the subband full duplex mode of operation; and
include, in the first random access message transmitted via the second random access occasion of the second set of random access occasions, an indication of the capability of the UE to support the subband full duplex mode of operation.

6. The UE of claim 5, wherein the one or more processors are individually or collectively further operable to execute the code to cause the UE to:
override a selection of the first random access occasion according to a probability value based at least in part on a determination to transmit the indication of the capability via the first random access message, wherein selection of the second random access occasion is based at least in part on the overriding.

7. The UE of claim 1, wherein the one or more processors are individually or collectively further operable to execute the code to cause the UE to:
receive, via the second control signaling, an indication of a second probability value for reselection of a random access occasion; and
transmit, based at least in part on failure of a first random access procedure and in accordance with the second probability value, a second random access message via a third random access occasion of the first set of random access occasions or a fourth random access occasion of the second set of random access occasions.

8. The UE of claim 1, wherein the one or more processors are individually or collectively further operable to execute the code to cause the UE to:
receive, via the second control signaling, an indication of a threshold quantity of random access attempts;
transmit, based at least in part on a failure of a first random access procedure, a first set of one or more additional random access messages via the first set of random access occasions or the second set of random access occasions selected, in accordance with the indication, for transmission of the first random access message; and
transmit a second set of one or more additional random access messages based at least in part on a failure of one or more additional random access procedures corresponding to the first set of one or more additional random access messages and a total quantity of the first random access message and the first set of one or more additional random access messages satisfying the threshold quantity of random access attempts, wherein the first set of one or more additional random access messages is transmitted via one of the first set of random access occasions or the second set of random access occasions, and the second set of one or more additional random access messages is transmitted via the other of the first set of random access occasions or the second set of random access occasions.

9. The UE of claim 1, wherein the one or more processors are individually or collectively further operable to execute the code to cause the UE to:
receive, via the second control signaling, an indication of a threshold quantity of times the UE is to switch between transmission of random access messages via the first set of random access occasions and transmission of random access messages via the second set of random access occasions;
transmit one or more additional random access messages via the first set of random access occasions, the second set of random access occasions, or both; and
refrain from switching between the first set of random access occasions and the second set of random access occasions based at least in part on a quantity of times the UE has switched between the first set of random access occasions and the second set of random access occasions satisfying the threshold quantity.

10. The UE of claim 1, wherein the one or more processors are individually or collectively further operable to execute the code to cause the UE to:
receive, via the second control signaling, an indication of a first threshold quantity of preamble transmissions corresponding to the half duplex mode of operation, and a second threshold quantity of preamble transmissions corresponding to the subband full duplex mode of operation;
perform a first random access procedure corresponding to the first random access message via one of the first set of random access occasions or the second set of random access occasions, the first random access procedure comprising one or more retransmissions of the first random access message via the first set of random access occasions or the second set of random access occasions; and
switch to the other of the first set of random access occasions or the second set of random access occasions for a second random access procedure based at least in part on a quantity of the one or more retransmissions satisfying the first threshold quantity of preamble transmissions.

11. The UE of claim 10, wherein the one or more processors are individually or collectively further operable to execute the code to cause the UE to:
perform the second random access procedure corresponding to a second random access message via the other of the first set of random access occasions or the second set of random access occasions in accordance with the switching, the second random access procedure comprising one or more retransmissions of the second random access message via the other of the first set of random access occasions or the second set of random access occasions; and
refrain from switching back to the first set of random access occasions until a quantity of the one or more retransmissions of the second random access message satisfying the second threshold quantity of preamble transmissions.

12. The UE of claim 1, wherein the one or more processors are individually or collectively further operable to execute the code to cause the UE to:
receive, based at least in part on transmitting the first random access message via the second random access occasion of the second set of random access occasions, a random access response comprising an indication to default to the first set of random access occasions; and
transmit a second random access message via a random access occasion of the first set of random access occasions in accordance with the indication to default to the first set of random access occasions.

13. The UE of claim 1, wherein the one or more processors are individually or collectively further operable to execute the code to cause the UE to:
receive, via the second control signaling, a threshold quantity of preamble transmissions via the second set of random access occasions;
transmit a plurality of random access preambles comprising the first random access message via the second set of random access occasions; and
transmit one or more random access preambles via the first set of random access occasions based at least in part on a quantity of the plurality of random access preambles satisfying the threshold quantity of preamble transmissions.

14. The UE of claim 1, wherein the one or more processors are individually or collectively further operable to execute the code to cause the UE to:
transmit capability information indicating whether the UE supports switching between the first set of random access occasions and the second set of random access occasions, a threshold quantity of random access attempts the UE supports prior to switching between the first set of random access occasions and the second set of random access occasions, a threshold quantity of times the UE supports prior to switching between the first set of random access occasions and the second set of random access occasions, or any combination thereof.

15. A method for wireless communications at a user equipment (UE), comprising:
receiving first control signaling indicating a first set of random access occasions corresponding to a half duplex mode of operation, and a second set of random access occasions associated with a subband full duplex mode of operation;
receiving second control signaling comprising an indication corresponding to selection of a random access occasion from the second set of random access occasions; and
transmitting a first random access message via a first random access occasion of the first set of random access occasions or a second random access occasion of the second set of random access occasions in accordance with the indication.

16. The method of claim 15, further comprising:
receiving, via the second control signaling, an indication of a plurality of probability values comprising a probability value, each probability value of the plurality of probability values corresponding to a respective beam of a set of beams.

17. The method of claim 15, further comprising:
establishing a radio resource control connection with a network device, wherein the second control signaling comprises radio resource control signaling via the radio resource control connection.

18. The method of claim 15, further comprising:
operating in a radio resource control idle mode, wherein the second control signaling comprises system information.

19. The method of claim 15, further comprising:
selecting the second random access occasion of the second set of random access occasions based at least in part on a capability of the UE to support the subband full duplex mode of operation; and
including, in the first random access message transmitted via the second random access occasion of the second set of random access occasions, an indication of the capability of the UE to support the subband full duplex mode of operation.

20. A user equipment (UE) for wireless communications, comprising:
means for receiving first control signaling indicating a first set of random access occasions corresponding to a half duplex mode of operation, and a second set of random access occasions associated with a subband full duplex mode of operation;
means for receiving second control signaling comprising an indication corresponding to selection of a random access occasion from the second set of random access occasions; and
means for transmitting a first random access message via a first random access occasion of the first set of random access occasions or a second random access occasion of the second set of random access occasions in accordance with the indication.
